(19) United States
(12) Patent Application Publication
(10) Pub. No.: US 2021/0291474 A1
(43) Pub. Date: Sep. 23, 2021

(54) METHODS OF OPERATING A STAMPING PRESS AND STAMPING PRESSES FOR OPERATION ACCORDING TO THE METHODS

(71) Applicant: Bruderer AG, Frasnacht (CH)

(72) Inventors: Ugo De Santis, Roggwil (CH); Herbert Högger, Götzis (AT)

(21) Appl. No.: 17/260,710

(22) PCT Filed: Jul. 16, 2018
(86) PCT No.: PCT/EP2018/069300

§ 371 Date: Jan. 15, 2021

(51) Int. Cl. B30B 15/14; B30B 15/02; B30B 15/00

(52) U.S. Cl. CPC B30B 15/144; B30B 15/0041; B30B 15/026

(57) ABSTRACT

The invention relates to a method for operating a stamping press (1) with a ram (2) which acts against a bolster plate (3), in particular a fixed bolster plate (3), and whose ram position relative to the bolster plate (3) can be adjusted in the intended use, wherein the ram (2) carries a first die part (4) and the bolster plate (3) carries a second die part (5), wherein the two die parts (4, 5) provide associated stop faces (6a, 7a) which, when the die is completely closed, form one or more fixed stops within the die for limiting the closing dimension of the die (4, 5). In accordance with a first method according to the invention, the distance (a, a1, a2, a3) between the two die parts (4, 5) or a parameter (b1, b2, b3, c) representing said distance is monitored at a certain point (P1, P2, P3) of the ram movement in which the die (4, 5) is not fully closed, and the ram movement is changed as a function of the monitoring result. In accordance with a second method according to the invention, at least one of the fixed stops is monitored for stop contact in the intended use of the stamping press, and the ram position is changed as a function of the monitoring result. With the methods according to the invention, energy-efficient and low-wear process control is possible also for dies (4, 5) with fixed stops, regardless of the skill and experience of the operator.

### CROSS-REFERENCE TO RELATED APPLICATIONS

This application is a National Stage application of International Patent Application No. PCT/EP2018/069300, filed on Jul. 16, 2018, which is hereby incorporated by reference in its entirety.

### TECHNICAL FIELD

The present invention relates to methods of operating a stamping press, stamping presses for operation in accordance with the methods, and the use of such stamping presses for producing stampings for predetermined separation points in sheet metal surfaces in accordance with the generic terms of the independent patent claims.

### BACKGROUND

Today's high-speed stamping machines produce highly complex and precise parts. In order to produce such parts with a high cadence, a high repeatability of the die closing dimension is required. A change in the closing dimension of the die has negative effects on the accuracy of the parts.

If only stamping and/or forming operations are performed, dies without stops are usually used. With these dies, the closing dimension depends essentially on the position of the upper die part at bottom dead center of the crankshaft drive (BDC position/UT). Important parameters for a change in the BDC position are the speed of the crankshaft drive, the oil temperature (heating of the machine), the ambient temperature (changes during the course of the day) and the heating of the die.

From EP 0 732 194 B1, it is known to measure the BDC position in a stopless die and to keep it constant by changing the position of the ram. This allows the most important parameters to be compensated for in a relatively simple manner.

If precise stamping is required, e.g. with progression cutting dies, the dies are usually equipped with so-called fixed stops. These fixed stops have the function of forcibly limiting the closing dimension under operating conditions. The press is necessarily clamped at bottom dead center to ensure that the fixed stops make contact. Due to the aforementioned parameters of speed, oil temperature, ambient temperature and die heating, the degree of clamping can change significantly during operation, with the result that the press is additionally subjected to strong forces which are not involved in the actual process and, apart from wasting energy unnecessarily, can lead to increased wear of the press.

The solution known from EP 0 732 194 B1 is not applicable here, since the closing dimension in operation is determined independently of the degree of clamping via the fixed stops and is always the same.

Accordingly, the problem arises that automated process control is hardly possible with such dies with fixed stops and it is essentially left to the skill and experience of the operator to run the process as energy-efficiently and with as little wear as possible.

### SUMMARY

The task is therefore to provide a technical solution as a remedy.

This task is solved by the methods and stamping presses according to the independent patent claims.

According to these, a first aspect of the invention relates to a method of operating a stamping press, in particular with a die, by means of which stampings for predetermined separation points are produced in sheet metal surfaces.

The stamping press comprises a ram which acts against a preferably fixed bolster plate. The position of the ram relative to the bolster plate, i.e. the relative position of the upward and downward movement of the ram relative to the bolster plate, can be adjusted during operation. The ram carries a first part of the die and the bolster plate carries a second part of the die. The two parts of the die have associated stop faces which, when the die is fully closed, form one or more fixed stops within the die for limiting the closing dimension of the die.

In accordance with the method according to the invention, in the intended use of the stamping press, the distance between the two die parts or a parameter representing this distance, i.e. a parameter from which the distance between the two die parts can be derived, is monitored at a certain point of the ram movement at which the die is not completely closed, and then the ram position is changed as a function of the monitoring result.

The die is not completely closed in the claimed sense if the closing dimension of the die is not limited by the or one of the fixed stops, i.e. no associated stop faces of the two die parts are in stop contact. This is independent of whether the die is in deformation contact with the workpiece or not.

With the method according to the invention, energy-efficient and low-wear process control is also possible for dies with fixed stops, regardless of the skill and experience of the operator.

Preferably, the distance between the two die parts or the parameter representing this distance is monitored at a point in the ram movement that is—closer to bottom dead center than to top dead center, preferably just before or just after bottom dead center. The closer this point is to the bottom dead center, the more precisely the process can be controlled.

In a first preferred embodiment of the method, the distance between the two die parts or the parameter representing this distance is monitored at a point in the ram movement at which the die is not in deformation contact with the workpiece, i.e. does not act on the workpiece, so that the ram does not perform any work. This has the advantage that the monitoring cannot be disturbed by any effects caused by the stamping stroke.

In an alternative second preferred embodiment of the method, the distance between the two die parts or the parameter representing this distance is monitored at a point in the ram movement at which the die is in deformation contact with the workpiece, i.e. acts on the workpiece so that the ram performs work. This embodiment has the advantage that monitoring takes place under operating conditions that are very similar to the conditions at bottom dead center. This enables particularly precise process control.

Depending on the die-cutting process, one or the other embodiment may be more preferred.

The ram movement is preferably generated by a crank drive or an eccentric drive, in particular in such a way that a 360° rotation of a crank or eccentric shaft is converted into a complete downward movement and a complete upward movement of the ram between a top and bottom dead center of the ram movement. Such slide drives are state of the art in high-speed stamping presses.

Accordingly, in such stamping presses it is preferable to monitor the—distance between the two die parts or the parameter representing this distance at a specific angular position of the crank drive or eccentric drive at which the die is not completely closed, and then to change the ram position depending on the—monitoring result. The angular position can be determined exactly and is therefore particularly suitable for determining the point of the ram movement at which the—distance between the two die parts or the parameter representing this distance is monitored.

Advantageously, monitoring takes place at an angular position which lies in a range of plus/minus 35° around bottom dead center. It has been shown that this angular position range is particularly suitable for monitoring the distance between the two die parts or the parameter representing this distance.

In a preferred embodiment of the method according to the invention, in the intended use, the distance between the two die parts or the parameter—representing this distance is kept constant at the specific point of the ram—movement or at the specific angular position by setting the die position as a function of the monitoring result, either manually or automatically. This facilitates to keep the degree of clamping of the press at the bottom dead center essentially constant over the entire operation, regardless of the parameters of speed, oil temperature, ambient temperature and die heating, such that uniform product quality can be ensured.

If the distance between the two die parts or the parameter representing this distance is set to a specific value at the specific point of the ram movement or at the specific angular position, in particular to an empirically determined value at which a desired production result is achieved, and is then kept constant at this value by setting the ram position as a function of the monitoring result, optimum production results can be achieved with high efficiency and minimum mechanical stress on the press.

Also, according to a preferred embodiment, it is intended to monitor the distance of the two die parts from each other or a parameter representing this distance at several points of the ram movement, e.g. both shortly before and shortly after bottom dead center, and then to change the ram position depending on this monitoring result.

A second aspect of the invention relates to a further method for operating a stamping press, in particular with a die, with which stampings for predetermined separation points are produced in sheet metal surfaces.

The stamping press comprises a ram which acts against a preferably fixed bolster plate and whose ram position relative to the bolster plate is—adjustable in the intended use. The ram carries a first part of the die and the bolster plate carries a second part of the die. The two die parts have associated stop faces which, when the die is fully closed, form one or more fixed stops within the die for limiting the closing dimension of the die.

According to this method, in the intended use of the stamping press, at least one of the fixed stops is monitored for stop contact, and the ram position is changed depending on the monitoring result.

With this second method according to the invention, it is also possible to implement energy-efficient and low-wear process control for dies with fixed stops, regardless of the skill and experience of the operator.

In this method, monitoring for stop contact can be performed directly or indirectly, i.e. by recording effects caused by the stop contact (direct) or parameters that indicate or represent a stop contact (indirect).

Thus, according to a preferred embodiment of the second method, an electrical contact is established or closed by the contact of the respective stop faces which generates a contact signal for monitoring.

Advantageously, in a first embodiment, one of the stop faces at at least one of the fixed stops has two contacts which are short-circuited by the other stop face to generate the contact signal on stop contact.

In another preferred embodiment, the two contact surfaces of at least one of the fixed stops form a contact pair which is closed to generate the contact signal when contact is made.

These direct monitoring variants using stop faces that also represent electrical contacts can be implemented in a simple manner and are robust and reliable in operation.

In a further preferred embodiment of the second method, a deformation of a body of the die or a die area, which provides one of the contact surfaces of a fixed stop, taking place under the stop pressure is detected to monitor the fixed stop for stop contact, e.g. by means of strain gauges and/or piezo elements.

In yet another preferred embodiment of the second method, a—parameter representing the stop contact is monitored.

According to a preferred variant, this is done in such a way that the bodies formed by the two die parts or carried by them are preferably monitored without contact for a relative position to each other representing the stop contact, e.g. for a reference dimension which is only reached at stop contact.

In a further preferred variant, one or more reference stops are—monitored for stop contact, which are each formed by mutually assigned stop faces of the two die parts and at whose stop contact the monitored fixed stop or stops also have stop contact. This is done, for example, in such a way that, as described above, that a deformation of a body, which provides one of the contact surfaces of the respective reference stop, taking place under the stop pressure is detected.

In the second method according to the invention, the ram movement is preferably generated by a crank drive or eccentric drive, in particular in such a way that a 360° revolution of a crank or eccentric shaft is converted into a—complete downward movement and a subsequent complete upward movement of the ram between a top and bottom dead center of the ram movement. Such slide drives are state of the art in high-speed stamping presses.

In yet another preferred embodiment of the second method, the movement of the first die part or of the ram relative to the fixed press structure, relative to the bolster plate or relative to the second die part is monitored in the region of the bottom dead center of the ram movement and the ram position is changed as a function of the monitoring result.

In a preferred variant, this is done in such a way that the time or the angle of rotation of the crank drive or eccentric drive is monitored during which the first die part or the ram does not perform any relative movement with respect to the fixed press structure, with respect to the bolster plate or with respect to the second die part in the region of the bottom dead center of the ram movement, and the ram position is changed as a function of this time or this angle of rotation. In this way, relatively simple and precise monitoring is possible.

In yet another preferred embodiment of the second method, the drive torque curve or the power consumption curve of the press drive is monitored in the area of the bottom dead center of the ram movement and the ram position is changed depending on the monitoring result.

According to a preferred variant, this is done in such a way that the time or the angle of rotation of the crank drive or eccentric drive is monitored during which the drive torque or the power consumption in the area of the bottom dead center of the ram movement has a certain course or exceeds a certain threshold value, and the ram position is changed as a function of this time or this angle of rotation.

In another variant, the maximum value reached by the drive torque or the power consumption in the area of the bottom dead center of the ram movement is monitored and the ram position is changed depending on the monitoring result.

Such variants based on the drive torque curve or the power consumption curve of the press drive have the advantage that no sensors are required in the actual working area of the stamping press, which is why they are very reliable.

In yet another preferred embodiment of the second method, the duration of the stop contact of one or more fixed stops is kept constant in the intended use, either manually or automatically, by adjusting the position of the impact as a function of the monitoring result. This makes it possible to keep the degree of clamping of the press at bottom dead center essentially constant during the entire operation, irrespective of parameters such as rotation speed, oil temperature, ambient temperature and die heating, so that uniform product quality and efficient, low-wear operation can be ensured.

It is preferred that the ram position is set as a function of the monitoring result in such a way that a specific stop contact duration results, preferably the—shortest possible stop contact duration. In this way, optimum production results can be achieved with high efficiency and minimum mechanical stress on the press.

In yet another preferred embodiment of the second method, the die of the stamping press has several monitored fixed stops. In this case, a specific configuration of these monitored fixed stops is brought into stop contact in the intended use, preferably automatically, by adjusting the ram position as a function of the monitoring result during each working stroke.

Preferably, the ram position is adjusted as a function of the monitoring result in such a way that the fixed stop of the constellation, which comes into contact last, is in contact for as short a time as possible. Also in this way, optimum production results can be achieved with such high-efficiency dies while minimizing mechanical stress on the press.

Advantageously, in the methods according to the first and second aspects of the invention, the die is used to produce stampings for predetermined separation points in sheet metal surfaces, preferably predetermined separation points in sheet metal surfaces for container lids with a tear-off or press-in tab. In such applications, the advantages of the processes according to the invention kick in particularly clearly.

A third aspect of the invention relates to a first stamping press for operation in accordance with the method according to the first aspect of the invention.

The stamping press comprises a preferably fixed bolster plate and a ram which acts against the bolster plate. The position of the ram relative to the bolster plate is adjustable in the intended operation. The ram carries a first die part and the bolster plate carries a second die part. The two die parts provide associated stop faces which, when the die is completely closed, form one or more fixed stops within the die for limiting the closing dimension of the die. Stamping dies of this type are typically used when high-precision stamping has to be produced, e.g. predetermined separation points in can lid blanks.

The stamping press has devices for controlling the ram position, by means of which, in the intended operation of the stamping press, the distance between the two die parts or a parameter representing this distance can be monitored at a specific point of the ram movement at which the die is not—completely closed, as described in the first aspect of the invention, and the ram position can be changed as a function of the monitoring result.

As already mentioned, the die is not completely closed in the claimed sense if the closing dimension of the die is not limited by the or one of the fixed stops, i.e. none of the assigned stop faces of the two die parts are in stop contact. This is independent of whether or not the die is in deformation contact with the workpiece.

With the stamping press according to the invention, energy-efficient and low-wear production is possible even with dies with fixed stops, regardless of the skill and experience of the operator.

In a preferred embodiment of the stamping press, its devices for controlling the ram position are configured such that the distance between the two die parts or the parameter representing this distance can be monitored at a point of the ram movement which is closer to the bottom dead center of the ram movement than to the top dead center thereof. Preferably, this point is located shortly before or shortly after the bottom dead center. The closer this point is to the bottom dead center, the more precisely the process can be controlled.

In a first variant, the devices for controlling the ram position are configured such that the distance between the two die parts or the parameter representing this distance can be monitored at a point of the ram movement at which the die is not in deformation contact with the workpiece, i.e. does not act on the workpiece such that the ram does not perform any work. This has the advantage that an interference in the monitoring by possible effects caused by the work of the ram can be prevented.

In an alternative second variant of the device, the devices for controlling the ram position are configured such that the distance between the two die parts or the parameter representing this distance can be monitored at a point of the ram movement at which the die is in deformation contact with the workpiece, i.e. acts on the workpiece so that the ram performs work. This variant has the advantage that the monitoring can take place under operating conditions that are very similar to the conditions at bottom dead center, which makes particularly precise process control possible.

Depending on the stamping process carried out on the stamping press, one or the other variant may be more preferable.

According to a preferred variant of the stamping press, the devices for controlling the ram position are configured such that the distance between the two die parts or a parameter representing this distance can be monitored both before and after the bottom dead center of the ram movement and the ram position can then be changed as a function of these monitoring results.

Preferably, the stamping press has a crank drive or eccentric drive for generating the ram movement. A 360° revolution of a crankshaft or eccentric shaft is converted into a complete downward movement and a complete upward movement of the ram between a top and a bottom dead center of the ram movement. Such stamping presses are state of the art for the production of punched parts with a high cadence.

Accordingly, in such stamping presses it is preferable to monitor the—distance between the two die parts or the parameter representing this distance at a specific angular position of the crank drive or eccentric drive at which the die is not completely closed, and then to change the ram position depending on the—monitoring result. The angular position can be determined exactly and is therefore particularly suitable for determining the point of the ram movement at which the—distance between the two die parts or the parameter representing this distance is monitored.

Advantageously, the devices for controlling the ram position are configured such that they can be used to monitor the distance between the two die parts or the parameter representing this distance at an angular position which lies in a range of plus/minus 35° around the bottom dead center. It has been shown that this angular position range is particularly suitable for monitoring the distance between the two die parts or a parameter representing this distance.

In yet another preferred embodiment of the first stamping press, the devices for controlling the ram position are configured such that the distance between the two die parts, or the parameter representing this distance, can be kept constant at the specific point of the ram movement or at the specific angular position during intended operation by adjusting the ram position as a function of the monitoring result. This makes it possible to keep the degree of clamping of the press at bottom dead center essentially constant over the entire operation,—independent of parameters such as rotation speed, oil temperature, ambient temperature and die heating, so that a uniform product quality and efficient, low-wear operation can be ensured.

Advantageously, the devices for controlling the ram position are configured such that the distance between the two die parts or the parameter representing this distance can be set to a specific value at the specific point of the ram movement or at the specific angular position, preferably to an empirically determined value at which a desired production result is achieved, and can then be kept constant at this value automatically by adjusting the ram position as a function of the monitoring result. With such stamping presses according to the invention, optimum production results can be achieved with high efficiency and minimum mechanical stress on the press.

A fourth aspect of the invention relates to a further stamping press for operation in accordance with the method according to the second aspect of the invention.

This second stamping press also comprises a preferably fixed bolster plate and a ram which acts against the bolster plate. The position of the ram relative to the bolster plate is also adjustable in the intended operation. The ram carries a first die part and the bolster plate carries a second die part. The two die parts provide associated stop faces which, when the die is completely closed, form one or more fixed stops within the die for limiting the closing dimension of the die.

The stamping press has devices for controlling the ram position, with which at least one of the fixed stops of the die can be monitored for stop contact during the intended operation of the stamping press and the ram position can be changed depending on the monitoring result.

As already mentioned, the die is not completely closed in the claimed sense if the closing dimension of the die is not limited by the or one of the fixed stops, i.e. no associated stop faces of the two die parts are in stop contact. This is independent of whether or not the die is in deformation contact with the workpiece.

With the second stamping press according to the invention, energy-efficient and low-wear production is also possible with dies with fixed stops,—regardless of the skill and experience of the operator.

In a preferred embodiment of the second stamping press, the die is configured such that the contact of the respective stop faces establishes or closes an electrical contact which generates a contact signal for the devices for controlling the ram position.

In a first variant, one of the stop faces of at least one of the fixed stops advantageously has two contacts, which are short-circuited by the other stop face for generating the contact signal upon stop contact.

In another preferred variant, the two stop faces of at least one of the fixed stops of the die form a contact pair, which is closed for generating the contact signal upon stop contact.

In a further preferred embodiment of the second stamping press, the die and the devices for controlling the ram position are configured such that a deformation of a body of the die or of a die area which provides one of the contact surfaces of a fixed stop can be detected under the stop pressure in order to monitor the fixed stop for stop contact, in particular by means of strain gauges and/or piezo elements, and the ram position can be changed as a function thereof.

In yet another preferred embodiment of the second stamping press, the devices for controlling the ram position are configured such that a parameter representing the stop contact can be monitored.

In a preferred variant, the devices for controlling the ram position are configured such that the bodies formed by the two die parts or carried by them can preferably be monitored without contact for a relative position to one another representing the stop contact, e.g. for a reference dimension which is only—reached upon stop contact.

In a further preferred variant of the second stamping press, the die and the devices for controlling the ram position are configured such that one or more reference stops formed by associated stop faces of the two die parts, at whose stop contact the monitored fixed stop or stops have stop contact, can be monitored for stop contact, in particular in such a way that through the contact of the stop faces of the respective stop faces an electrical contact is made or closed which generates a contact signal, or that a deformation of a body providing one of the contact surfaces of the respective reference stop, which takes place under the stop pressure, can be detected.

The second stamping press also preferably has a crank drive or eccentric drive for generating the ram movement, with which a 360° revolution of a crank or eccentric shaft is converted into a complete downward movement and a complete upward movement of the ram between a top and a bottom dead center of the ram movement. As has already been mentioned, such stamping presses are state of the art for the production of punched parts with a high cadence.

In yet another preferred embodiment of the second stamping press, the devices for controlling the ram position are configured such that the course of movement of the first die part or of the ram relative to the fixed press structure, relative to the bolster plate or relative to the second die part can be monitored in the region of the bottom dead center of the ram movement, and the ram position can be changed as a function of the monitoring result.

In a preferred variant, the devices for controlling the ram position, for this purpose, are configured such that the time or the angle of rotation of the crank drive or eccentric drive can be monitored during which the first die part or the ram does not perform any relative movement with respect to the stationary press structure, with respect to the bolster platen or with respect to the second die part in the region of the bottom dead center of the ram movement, and the ram position can be changed as a function of this time or this angle of rotation. This enables relatively simple and precise monitoring.

In yet another preferred embodiment of the second stamping press, the devices for controlling the ram position are configured such that the drive torque curve or the power consumption curve of the crank drive or eccentric drive can be monitored in the region of the bottom dead center of the ram movement and the ram position can be changed as a function of the monitoring.

According to a preferred variant, the devices for controlling the ram position are configured such that the time or the angle of rotation of the crank or eccentric drive can be monitored, during which the drive torque or the power—consumption in the area of the bottom dead center of the ram movement has a certain course or exceeds a certain threshold value, and the ram position can be changed depending on the monitoring result.

It is also preferred that the devices for controlling the ram position are configured such that the maximum value reached by the drive torque or the power consumption in the area of the bottom dead center of the ram movement can be monitored, and the ram position can be changed depending on the monitoring result.

Such monitoring devices based on the drive torque curve or the power consumption curve of the press drive have the advantage that they do not require any sensors in the actual working space of the stamping press, which makes them very reliable.

In yet another preferred embodiment of the second stamping press, the devices for controlling the stamping position are configured such that, in the intended operation, the duration of the contact cycle of one or more fixed stops can preferably be kept constant automatically by adjusting the ram position as a function of the monitoring result. This makes it possible to keep the degree of clamping of the press at bottom dead center essentially constant over the entire operation, independent of parameters such as speed, oil temperature, ambient—temperature and die heating, so that uniform product quality can be ensured.

It is preferred that the devices for controlling the ram position are configured such that the ram position can be adjusted as a function of the monitoring result in such a way that a specific stop contact duration results, preferably the shortest possible stop contact duration. In this way, optimum production results can be achieved with high efficiency and minimum mechanical stress on the press.

In yet another preferred embodiment of the second stamping press, the die of the stamping press has several monitored fixed stops and the devices for controlling the ram position are configured such that, in the intended operation, a specific constellation of these monitored fixed stops can preferably be brought into stop contact automatically by adjusting the ram position as a function of the monitoring result during each working stroke.

Preferably, the devices for controlling the ram position are configured such that the stop position can be adjusted as a function of the monitoring in such a way that a fixed stop of the constellation coming in stop contact last is in contact with the stop for the shortest possible time. Also in this way, optimum production results can be achieved with a high degree of efficiency and minimum mechanical stress on the press.

A fifth aspect of the invention relates to the use of the stamping presses according to the third and fourth aspects of the invention for producing stampings for predetermined separation points in sheet metal surfaces, preferably for predetermined separation points in sheet metal surfaces for container lids with tear-off or press-in tabs. The advantages of the invention are particularly evident in such applications.

### BRIEF DESCRIPTION OF THE DRAWINGS

Further preferred embodiments of the invention are apparent from the dependent claims and from the following description with reference to the figures. Therein showing:

FIG. 1 a front view of a stamping press according to the invention with a stamping die with fixed stops; and

FIGS. 2 to 10 each show the detail X from FIG. 1 with the associated ram movement curve in various embodiments and operating modes of the stamping press according to the invention.

### DETAILED DESCRIPTION

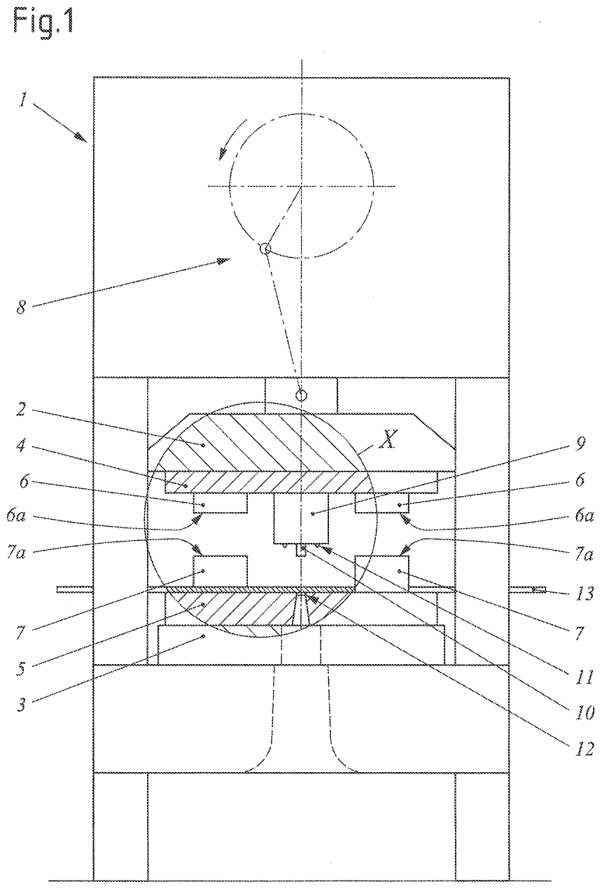

FIG. 1 shows a highly abstracted front view of a high-speed stamping press 1 according to the invention for the production of punched parts with high-precision stampings for predetermined separation points in sheet metal surfaces, such as blanks for container lids with tear-off or press-in tabs.

As can be seen, the press 1 has a fixed bolster plate 3 and a ram 2 which acts against the bolster plate 3. The ram position, i.e. the relative position of the upward and downward movement of the ram 2 in relation to the bolster plate 3, can be adjusted during operation.

The ram 2 carries an upper die part 4 (the first die part according to the claims), which has a punch 9 with a punching mandrel 10 and a punching projection 11 around the punching mandrel 10.

The bolster plate 3 carries a lower die part 5 (the second die part according to the claims), which forms a support surface for the material strip 13 to be processed and a die element 12 for the punching mandrel 10 of the upper die part 4. The two die parts 4 and 5 together form the punching and stamping die 4, 5 of the press 1. They each have stop bodies 6, 7, which provide associated stop faces 6a, 7a which, when the die 4, 5 is fully closed, form fixed stops within the die for limiting the closing dimension of the die 4, 5.

The stamping press 1 has a crank drive 8 for generating the ram movement (symbolically shown with dashed lines), which converts a 360° rotation of a crankshaft into a complete downward movement and a subsequent complete upward movement of the ram 2 between a top dead center and a bottom dead center UT of the ram movement.

In the intended operation of the stamping press 1, the material strip 13 to be processed is fed intermittently from right to left through the press 1 by means of a strip feed (not shown).

Furthermore, press 1 has a press control system (not shown) with devices for controlling the ram position.

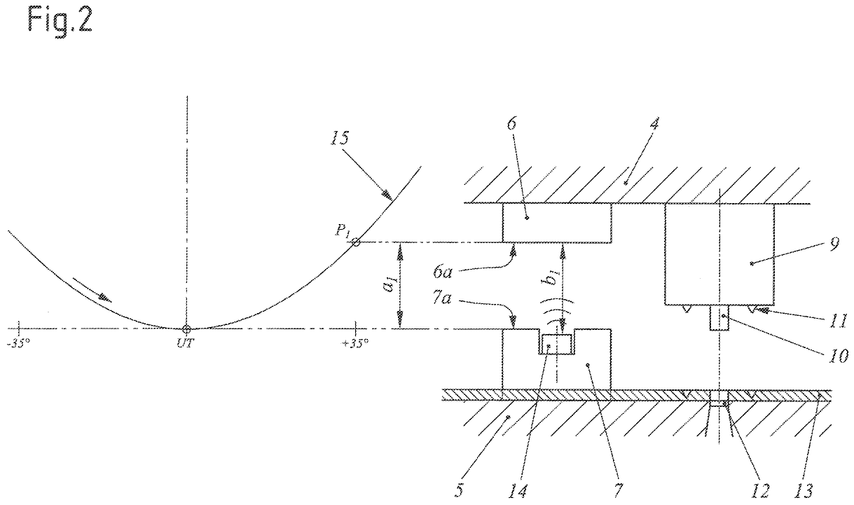

In FIGS. 2 to 10, various modes of operation and embodiments of the stamping press 1 according to the invention are explained on the basis of the detail X from FIG. 1 and on the basis of an associated ram movement curve 15 for an angle of rotation range of the crank drive from about 35° before bottom dead center UT to about 35° thereafter.

The distances, the thickness of the strip material 13 and, in particular, the height of the punching projection 11 are significantly enlarged for the sake of clarity.

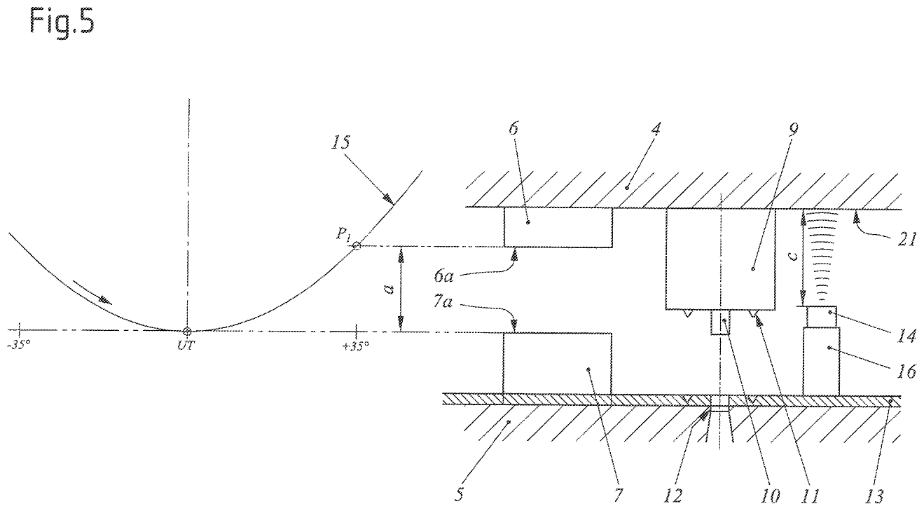

In the first embodiment of the stamping press 1 according to the invention illustrated in FIGS. 2 to 4 and in the second embodiment of the stamping press 1 illustrated in FIG. 5, the press control is configured such that, in the intended operation of the stamping press 1, the distance a, a1, a2, a3 of the two die parts 4, 5 from one another or a parameter b1, b2, b3, c representing this distance is measured at a specific point P1, P2, P3 of the ram movement, at which the die 4, 5 is not completely closed, can be monitored and the ram position can be changed as a function of the monitoring result, preferably in such a way that constant closing conditions of the die 4, 5 at the bottom dead center of the ram movement are present throughout the entire production operation.

In this way, it is possible to compensate to a large extent for the influence of parameters affecting the closing dimension, such as die and machine heating, ambient temperature and speed of the crank drive, and to ensure essentially identical die closing conditions at bottom dead center throughout—operation.

In the first embodiment of the stamping press 1 according to FIGS. 2-4, the lower stop body 7 has, in its center set back from the stop face 7a, a—contactless distance sensor 14 which, in the intended operation of the press 1,—serves to determine the distance to the stop face 6a of the associated stop body 6 of the upper die half 4. In the present case, this sensor 14 is an inductive distance sensor or a laser distance sensor.

As can be seen from the illustration according to FIG. 2 in combination with the associated ram movement curve 15 shown next to it, the ram 2 in the situation shown here—shortly after the punching and embossing process has been completed—is in the upward movement in a position which corresponds to a rotational angle position P1 of the crank drive of 35° after the UT (+35°). In this position, the stop faces 6a, 7a of the stop bodies 6, 7 shown have a distance a1 from each other. In this situation, the die 4, 5 is not in deformation contact with the material band 13 and therefore does not perform any work.

In the first mode of operation of the first embodiment of the stamping press 1 illustrated here, the press control uses the sensor 14 to determine the distance a1 between the stop faces 6a, 7a or a reference distance, e.g. the—distance b1 between the sensor 14 and the stop face 6a of the upper stop body 6, for each punch stroke or at certain intervals in the illustrated angle of rotation P1 (35° to UT) and compares this with a target value.

This determination of the distance a1 or the reference distance b1 and comparison of it with a target value corresponds to the monitoring of the distance between the two die parts or of a parameter representing this distance (reference distance) according to the claims.

When a deviation from the target value is detected, the press control changes the ram position, in this case in such a way that the deviation from the target value is reduced or eliminated as monitoring continues.

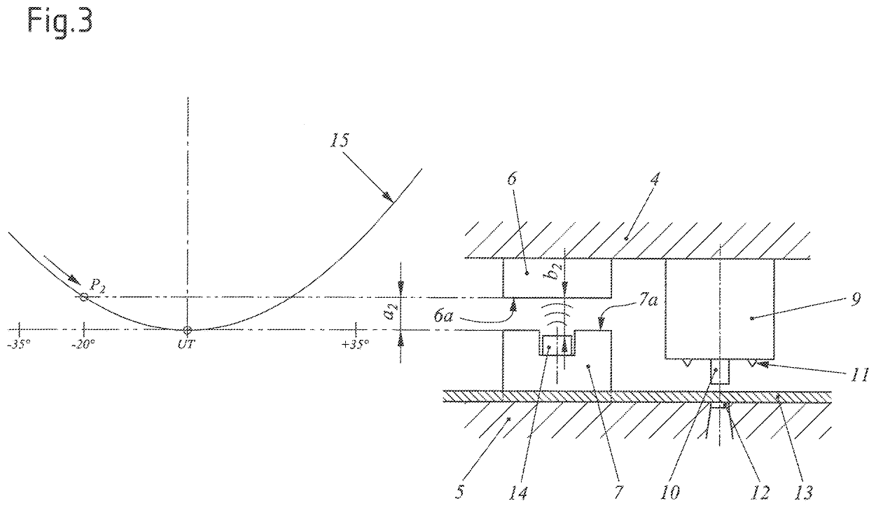

FIG. 3 illustrates a second mode of operation of the first embodiment of the stamping press 1 in accordance with the invention. As can be seen in conjunction with the associated ram movement curve 15, in the situation shown, the ram 2 is in the downward movement—shortly before the punching and stamping process—in a position which corresponds to an angle of rotation position P2 of the crank drive of 20° before the UT (−20°). In this position, the stop faces 6a, 7a of the stop bodies 6, 7 shown are at a distance a2 from each other and the sensor 14 is at a distance b2 from the stop surface 6a of the upper stop body 6. In this situation, the die 4, 5 is not in deformation contact with the material strip 13 and consequently does not perform any work. The second mode of operation of the stamping press 1 illustrated here differs from that illustrated in FIG. 2 only in that here the distance a2 between the stop faces 6a, 7a or the reference distance b2 is determined in each case at the angle of rotation position P2 of the crank drive (20° before UT) and compared with a corresponding target value. Monitoring the distance a2 of the two die parts 4, 5 from each other or a reference distance b2 representing this distance at the angle of rotation position P2 shortly before the punching mandrel 10 and the punching projection 11 hit the material strip 13 has the advantage that the acceleration forces acting on the system are very similar to those at bottom dead center, but there are not yet any system vibrations excited by the punching impact which could interfere with the measurement. Accordingly, very reliable and precise monitoring is possible in this way.

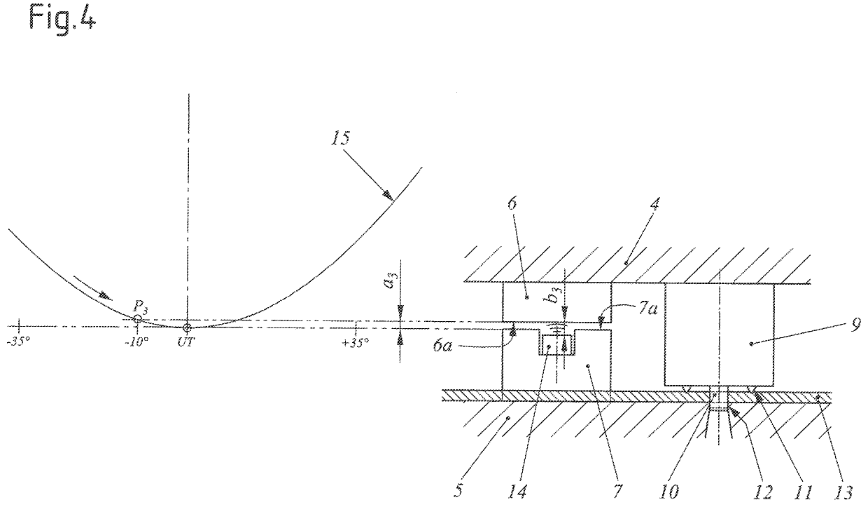

FIG. 4 illustrates a third mode of operation of the first embodiment of the stamping press 1 in accordance with the invention. As can be seen in conjunction with the associated ram movement curve 15, in the situation shown in FIG. 4, the ram 2 is in a position in the downward movement during the punching and stamping process which corresponds to an angle of rotation position P3 of the crank drive of 10° before the UT (−10°). In this position, the stop faces 6a, 7a of the stop bodies 6, 7 shown have a distance a3 from each other and the sensor 14 has a distance b3 from the stop face 6a of the upper stop body 6. The punching mandrel 10 has already completely penetrated the material strip 13 and entered the die element 12, and the punching projection 11 has just begun to penetrate the material strip 13. Accordingly, in this situation the die is in deformation contact with the material strip 13 and performs deformation work (stamping).

The third mode of operation of the stamping press according to the invention illustrated here differs from that illustrated in FIG. 3 only in that here the distance a3 between the stop faces 6a, 7a or the reference distance b3 is determined in each case at the angle of rotation position P3 of the crank drive (10° before UT) and compared with a corresponding target value. Monitoring the distance a3 between the two die parts 4, 5 or a reference distance b3—representing this distance at the angle of rotation position P3 after the punching mandrel 10 has penetrated the material strip 13 and during the penetration of the punching projection 11 into the material strip 13 has the advantage that the total forces acting on the system are very similar to those which occur in ideal operation at bottom dead center. Accordingly, this mode of operation allows particularly reliable and precise monitoring.

The second embodiment of the stamping press 1 according to FIG. 5 differs from the first embodiment according to FIGS. 2, 3 and 4 in that the distance sensor 14 is not arranged in the lower stop body 7, but on an auxiliary carrier 16, and in that it is used to determine the distance c between the sensor 14 and a reference surface 21 on the bottom side of the upper die half 4. This reference distance c is, like the reference distances b1, b2, b3 in the first embodiment of the stamping press 1, a parameter representing the distance between the stop faces 6a and 7a of the stop bodies 6, 7 according to the claims. The remaining construction of the stamping press 1 is identical to that according to the first embodiment and also the sensor 14 in the present case is also an inductive distance sensor or a laser distance sensor.

As can be seen from the illustration according to FIG. 5 in combination with the associated ram movement curve 15 shown next to it, the ram 2 in the situation shown here (as already in the situation shown in FIG. 2) is in a position shortly after the punching and stamping process has been completed in the upward movement, which corresponds to an angle of rotation position P1 of the crank drive of 35° after the UT (+35°). In this position, the stop faces 6a, 7a of the stop bodies 6, 7 shown have a distance a from each other. In this situation, the die is not in deformation contact with the material strip 13 and therefore does not perform any work.

In the mode of operation of the second embodiment of the stamping press 1 illustrated here in accordance with the invention, the press control system uses the sensor 14 to determine the distance a between the stop faces 6a, 7a or a reference distance, e.g. the distance c between the sensor 14 and the reference surface 21 on the bottom side of the upper die half 4, for each punch stroke or at specific intervals in each case in the illustrated angle of rotation position P1 (35° to UT), and compares this with a target value.

This determination of the distance a or the reference distance c and comparison of the same with a target value corresponds to the monitoring of the distance between the two die parts or of a parameter representing this distance (reference distance) according to the claims.

When a deviation from the target value is detected, the press control changes the ram position, in this case in such a way that the deviation from the target value is reduced or eliminated as monitoring continues.

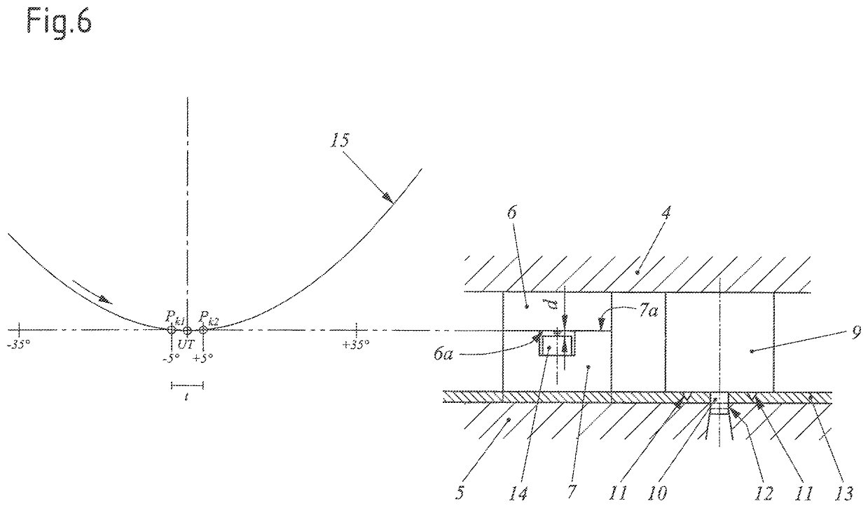

In the various embodiments of the stamping press 1 illustrated in FIGS. 6 to 10, the press control in accordance with the invention is configured such that it can be used to monitor at least one of the fixed stops for stop contact during the intended operation of the stamping press 1 and to change the ram position as a function of the monitoring result, preferably in such a way that constant closing conditions of the die 4, 5 are present at the bottom dead center of the ram movement throughout the entire production operation.

In this way, it is also possible to largely compensate for the influence of the parameters affecting the closing dimension, such as die and machine heating, ambient temperature and crankshaft speed, and to ensure essentially identical die closing conditions at bottom dead center (BDC=UT) throughout operation.

As can be seen from the associated ram movement curves 15, the ram 2 is in the bottom dead center UT of its movement in each of the situations shown in FIGS. 6 to 10. In this position, the stop faces 6a, 7a of the stop bodies 6, 7—shown rest against each other and thus form a fixed stop limiting the die closing dimension.

As can be seen from the associated ram movement curves 15, in the—situations shown in FIGS. 6 to 10, the point Pk1 at which the stop contact between the two stop faces 6a, 7a occurs is 5° before BDC (−5°) and the point Pk2 at which the stop contact is cancelled is 5° after BDC (+5°). Correspondingly, there is stop contact within an angle of rotation range of 10° (plus/minus 5° around BDC). At the existing speed of the crank drive 8 of the press 1 of 1000 rpm, stop contact is present here for a period t of 1.6 ms.

The third embodiment of the stamping press 1 illustrated in FIG. 6 differs from the first embodiment according to FIGS. 2 to 4 only in that it has a press control system which implements a different operating mode of the press according to the invention. In this embodiment, the press control does not determine the distance between the stop faces 6a, 7a or a reference distance at a specific angle of rotation position P1, P2 or P3, but instead determines the angle of rotation positions Pk1 and Pk2 or the angle of rotation range or the time interval without contact with the aid of the sensor 14. The angle of rotation range or the—time period t between which or within which there is no longer any distance between the surfaces 6a, 7a (stop contact) or between which or within which a specific minimum distance between the stop faces 6a, 7a is not reached. For this purpose, the press control evaluates the reference distance d between the sensor 14 and the stop surface 6a of the upper stop body 6, which represents the stop contact of the stop faces 6a and 7a or the determined minimum distance.

The determined angle of rotation positions Pk1, Pk2, angle of rotation ranges and/or time periods t are compared with target values. If the press control system detects a deviation from the target value, it changes the press position in such a way that the deviation from the target value is reduced or eliminated during continuous monitoring.

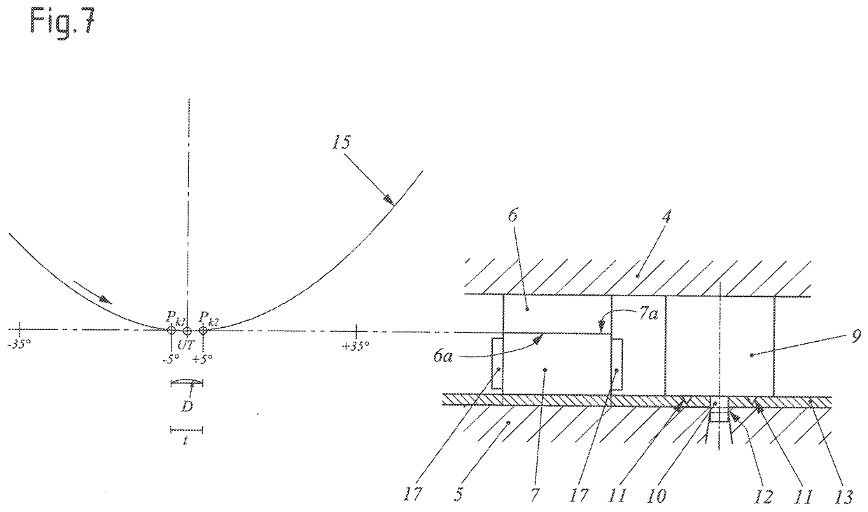

The fourth embodiment of the stamping press 1 according to FIG. 7 differs from the second embodiment according to FIG. 5 in that it does not have a distance sensor 14 for determining a reference distance representing the distance between the stop faces 6a, 7a, but rather two strain gauges 17 or piezo elements with which a deformation D of the lower stop body 7 can be determined when the upper stop body 6 is pressed with its stop surface 6a against the stop surface 7a of the lower stop body 7. It also has a press control system which implements a different operating mode of the press 1 in accordance with the invention.

In the present case, the press control uses the strain gauges 17 or piezo elements to determine the angle of rotation positions Pk1 and Pk2 or the angle of rotation range or the time period t between which or within which stop contact is made between the stop faces 6a, 7a. The determined angle of rotation positions Pk1, Pk2, angle of rotation ranges and/or time periods t are compared with target values. If the press control detects a deviation from the target value, it changes the ram position in such a way that the deviation from the target value is reduced or eliminated as monitoring continues.

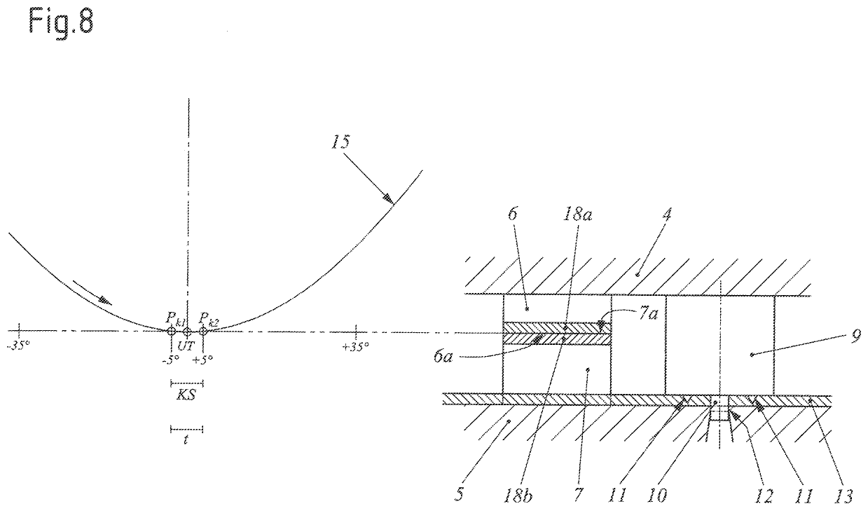

The fifth embodiment of the stamping press 1 according to FIG. 8 differs from the second embodiment according to FIG. 5 in that it does not have strain gauges 17 or piezo elements for determining a stop contact between the stop faces 6a, 7a, but instead these stop faces 6a, 7a are formed by electrical contact bodies 18a and 18b, which together form a contact pair 18a, 18b, which is closed to generate a contact signal KS on stop contact. It also has a press control which implements another mode of operation of the press according to the invention.

In this embodiment, the press control uses the contact pair 18a, 18b to determine the angle of rotation positions Pk1 and Pk2 or the angle of rotation range or the time period t between which or within which stop contact exists—between the stop faces 6a, 7a. The determined angle of rotation positions Pk1, Pk2, angle of rotation ranges and/or time periods t are compared with target values. If the press control system detects a deviation from the target value, it changes the ram position in such a way that the deviation from the set value is reduced or eliminated during continuous monitoring.

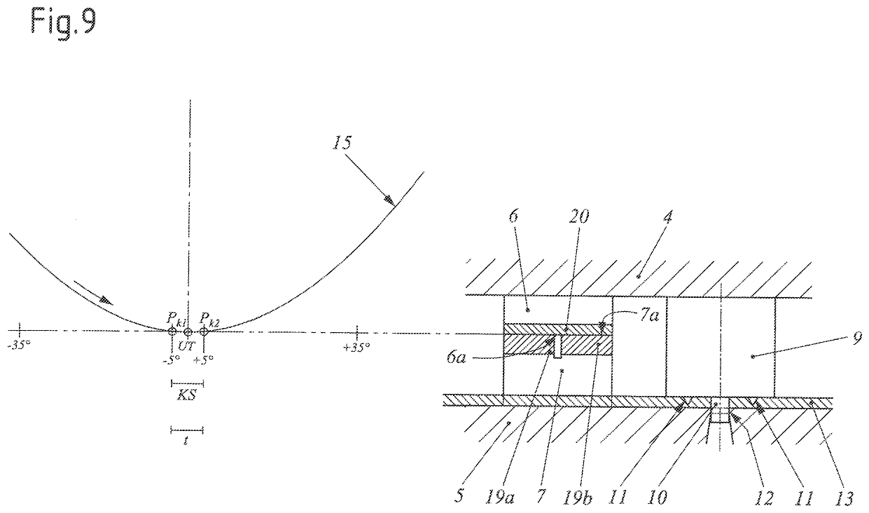

The sixth embodiment of the stamping press 1 according to FIG. 9 differs from the fifth embodiment according to FIG. 8 in that the stop face 7a of the lower stop body 7 is formed by two separate electrical contact bodies 19a and 19b, while the stop face 6a of the upper stop body 6 is formed by a single continuous contact body 20. The contact bodies 19a and 19b form two contacts 19a, 19b, which are short-circuited by the contact body 20 when a stop contact is made, thereby generating a contact signal KS.

The press control is identical here as in the fifth embodiment of the stamping press described above. With the aid of contacts 19a, 19b, it determines the angle of rotation positions Pk1 and Pk2 or the angle of rotation range or the time period t between which or within which stop contact exists between the stop faces 6a, 7a. The determined angle of rotation positions Pk1, Pk2, angle of rotation ranges and/or time periods t are compared with target values. If the press control system detects a deviation from the target value, it changes the ram position in such a way that the deviation from the target value is reduced or eliminated during continuous monitoring.

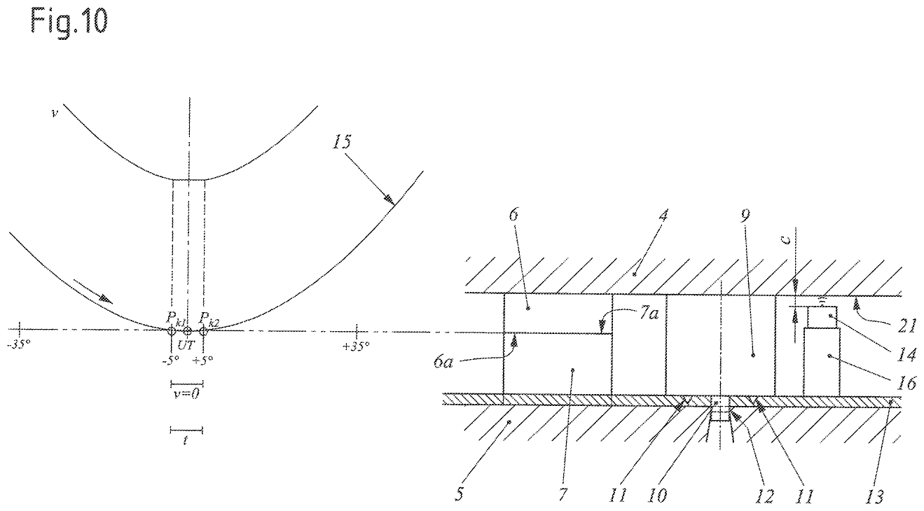

The seventh embodiment of the stamping press 1 illustrated in FIG. 10 differs from the second embodiment according to FIG. 5 only in that it has a press control which implements a different mode of operation of the press according to the invention. In this embodiment, the press control does not determine the—distance between the stop surfaces 6a, 7a or a reference distance at a specific angle of rotation position with the aid of the sensor 14, but it determines the angle of rotation positions Pk1 and Pk2 or the angle of rotation range or the period of time t, between which or within which the upper die half 4 does not perform a vertical movement due to a stop contact of the stop surfaces 6a, 7a (motion standstill), without contact and with the aid of the sensor 14 and the reference—surface 21 on the bottom side of the upper die half 4. For this purpose, the press control evaluates the change over time of the reference distance c between the sensor 14 and the reference surface 21 in the area around the bottom dead center UT.

The determined angle of rotation positions Pk1, Pk2, angle of rotation ranges and/or time periods t are compared with target values. If the press control system detects a deviation from the target value, it changes the ram position in—such a way that the deviation from the target value is reduced or eliminated during continuous monitoring.

While preferred embodiments of the invention are described in the present application, it should be clearly noted that the invention is not limited to these and may also be carried out in other ways within the scope of the following claims. In particular, it should also be explicitly mentioned that various combinations of the previously set forth modes of operation are also provided, to the extent that they are technically feasible.

What is claimed is:

1. A method of operating a stamping press with a ram which operates against a bolster plate, in particular a fixed bolster plate, and whose ram position relative to the bolster plate can be adjusted in the intended use, the ram carrying a first die part and the bolster plate carrying a second die part, wherein the two die parts provide associated stop faces which, when the die is fully closed, form one or more fixed stops within the die for limiting the closing dimension of the die,
wherein, in the intended use of the stamping press, the distance between the die parts or a parameter representing said distance at a specific point of the ram movement, at which the die is not fully closed, is monitored, and the ram position is changed as a function of the monitoring result.

2. The method according to claim 1, wherein the distance between the two die parts or the parameter representing said distance is monitored at a point of the ram movement which is closer to the bottom dead center of the ram movement than to the top dead center of the ram movement, in particular shortly before or shortly after the bottom dead center.

3. The method according to claim 2, wherein the distance of the two die parts from each other or the parameter representing said distance is monitored at a point of the ram movement at which the die is not in deformation contact with the workpiece.

4. The method according to claim 2, wherein the distance between the two die parts or the parameter representing said distance is monitored at a point of the ram movement at which the die is in deformation contact with the workpiece.

5. The method according to claim 1, wherein the ram movement is generated via a crank drive or an eccentric drive.

6. The method according to claim 5, wherein the distance of the two die parts from one another or the parameter representing said distance is monitored at a specific angular position of the crank drive or the eccentric drive at which the die is not completely closed, and the ram position is changed as a function of the monitoring result.

7. The method according to claim 6, wherein the angular position is within a range of plus/minus 35° around the bottom dead center.

8. The method according to claim 1, wherein the distance between the two die parts or the parameter representing said distance is kept constant at the specific point of the ram movement or at the specific angular position in the intended use by setting the ram position as a function of the monitoring result.

9. The method according to claim 8, wherein the distance between the two die parts or the parameter representing said distance at the specific point of the ram movement or at the specific ram position is set to a certain value, in particular to an empirically determined value, and is then automatically kept constant at this value by setting the ram position as a function of the monitoring result.

10. A method of operating a stamping press with a ram which operates against a bolster plate, in particular a fixed bolster plate, and whose ram position relative to the bolster plate can be adjusted in the intended use, the ram carrying a first die part and the bolster plate carrying a second die part, wherein the two die parts provide associated stop faces which, when the die is fully closed, form one or more fixed stops within the die for limiting the closing dimension of the die, wherein the ram movement of the stamping press is generated via a crank drive or an eccentric drive,
wherein, in the intended use of the stamping press, at least one of the fixed stops is monitored for stop contact, wherein the angle of rotation positions of the crank shaft or the eccentric shaft of the stamping press between which the stop contact exists, the angle of rotation of the crank shaft or the eccentric shaft of the stamping press within which the stop contact exists and/or the time period within which the stop contact exists are determined and are compared with target values, and the ram position is changed as a function of the monitoring result.

11. The method according to claim 10, wherein an electrical contact is made or closed by the contact of the associated stop faces, which generates a contact signal for monitoring the contact.

12. The method according to claim 11, wherein in at least one of the fixed stops one of the stop faces has two contacts which are short-circuited by the other stop face upon stop contact for generating the contact signal.

13. The method according to claim 11, wherein at at least one of the fixed stops, the stop faces form a contact pair which is closed at stop contact for generating the contact signal.

14. The method according to claim 10, wherein a deformation of a body, which provides one of the contact surfaces of a fixed stop, taking place under the stop pressure is detected for monitoring the fixed stop for stop contact.

15. The method according to claim 14, wherein the detection is performed by means of strain gauges and/or piezo elements.

16. The method according to claim 10, wherein a parameter representing the stop contact is monitored.

17. The method according to claim 16, wherein bodies formed by the two die parts or carried by them are monitored, in particular without contact, for a relative position to one another representing the stop contact.

18. The method according to claim 16, wherein one or more reference stops formed by associated stop faces of the two die parts, at the stop contact of which the monitored fixed stop or stops have stop contact, are monitored for stop contact, in particular in such a way that an electrical contact is made or closed by the contact of the stop surfaces of the respective reference stop, in particular in such a way that the contact of the stop faces of the respective reference stop makes or closes an electrical contact which generates a contact signal, or that a deformation of a body, which provides one of the contact surfaces of the respective reference stop, taking place under the stop pressure, is detected.

19. (canceled)

20. The method according to claim 10, wherein the relative movement of the first die part or of the ram with respect to the fixed press structure, the bolster plate or the second die part is monitored in the region of the bottom dead center of the ram movement, and the ram position is changed as a function of the monitoring result.

21. The method according to claim 20, wherein the time or the angle of rotation of the crank drive or the eccentric drive is monitored, during which the first die part or the ram does not perform any relative movement against the fixed press structure, the bolster plate or the second die part in the region of the bottom dead center of the ram movement, and the ram position is changed as a function of the monitoring result.

22. The method according to claim 10, wherein the drive torque characteristic or the power consumption characteristic of the press drive is monitored in the region of the bottom dead center of the ram movement, and the ram position is changed as a function of the monitoring result.

23. The method according to claim 22, wherein the time or the angle of rotation of the crank drive or eccentric drive is monitored during which the drive torque or the power consumption in the region of the bottom dead center of the ram movement has a certain course or exceeds a certain threshold value, and the ram position is changed as a function of the monitoring result.

24. The method according to claim 22, wherein the maximum value reached by the drive torque or the power consumption in the region of the bottom dead center of the ram movement is monitored and the ram position is changed as a function of the monitoring result.

25. The method according to claim 10, wherein, in the intended use, the duration of the stop contact of one or more fixed stops is kept constant, in particular automatically, by adjusting the ram position as a function of the monitoring result.

26. The method according to claim 25, wherein the ram position is adjusted as a function of the monitoring result in such a way that a specific stop contact duration results, in particular the shortest possible stop contact duration.

27. The method according to claim 10, wherein the die of the stamping press has several monitored fixed stops and, in the intended use, a specific constellation of these monitored fixed stops is brought into stop contact in each working stroke, in particular automatically, by setting the ram position as a function of the monitoring result.

28. The method according to claim 27, wherein the ram position is adjusted as a function of the monitoring result in such a way that a fixed stop of the constellation which comes into stop contact last is in stop contact for the shortest possible time.

29. The method according to claim 1, wherein the die is used to produce stampings for predetermined separation points in sheet metal surfaces, in particular predetermined separation points in sheet metal surfaces for container lids with tear-off or press-in tabs.

30. A stamping press for operation in accordance with the methods according to claim 1, comprising a bolster plate, in particular a fixed bolster plate, and a ram which acts against the bolster plate and whose ram position relative to the bolster plate can be adjusted in the intended use, wherein the ram carries a first die part and the bolster plate carries a second die part, wherein the two die parts provide associated stop faces which, when the die is completely closed, form one or more fixed stops within the die for limiting the closing dimension of the die,
wherein the stamping press has devices for controlling the ram position, by means of which, in the intended use of the stamping press, the distance between the two die parts or a parameter representing said distance at a specific point of the ram movement at which the die is not completely closed can be monitored, and the ram position can be changed as a function of the monitoring result.

31. The stamping press according to claim 30, wherein the devices for controlling the ram position are configured such that the distance of the two die parts from each other or the parameter representing said distance can be monitored at a point of the ram movement which is closer to the bottom dead center of the ram movement than to the top dead center of the ram movement, in particular shortly before or shortly after the bottom dead center.

32. The stamping press according to claim 31, wherein the devices for controlling the ram position are configured such that the distance between the two die parts or the parameter representing said distance can be monitored at a point of the ram movement at which the die is not in deformation contact with the workpiece.

33. The stamping press according to claim 31, wherein the devices for controlling the ram position are configured such that the distance between the two die parts or the parameter representing said distance can be monitored at a point of the ram movement at which the die is in deformation contact with the workpiece.

34. The stamping press according to claim 30, wherein the stamping press has a crank drive or eccentric drive for generating the ram movement.

35. The stamping press according to claim 34, wherein the devices for controlling the ram position are configured such that the distance between the two die parts or the parameter representing said distance can be monitored at a specific angular position of the crank drive or eccentric drive at which the die is not completely closed, and the ram position can be changed as a function of the monitoring result.

36. The stamping press according to claim 35, wherein the devices for controlling the ram position are configured such that the monitoring can take place at an angular position in a range of plus/minus 35° around the bottom dead center.

37. The stamping press according to claim 30, wherein the devices for controlling the ram position are configured such that, in the intended use, the distance between the two die parts or the parameter at the specific point of the ram movement or at the specific ram position can be kept constant by adjusting the ram position as a function of the monitoring result.

38. The stamping press according to claim 37, wherein the devices for controlling the ram position are configured such that the distance between the two die parts or the parameter representing said distance can be set to a specific value at the specific point of the ram movement or at the specific angular position, in particular to an empirically determined value, and can then be kept constant at this value in an automated manner by setting the ram position as a function of the monitoring result.

39. A stamping press for operation according to claim 10, comprising a bolster plate, in particular a stationary bolster plate, and a ram which acts against the bolster plate and whose ram position relative to the bolster plate can be adjusted in the intended use, the ram carrying a first die part and the bolster plate carrying a second die part, the two die parts providing associated—stop faces which, when the die is completely closed, form one or more fixed stops within the die for limiting the closing dimension of the die, wherein the stamping press has a crank drive or an eccentric drive for generating the ram movement,
wherein the stamping press has devices for controlling the ram position, with which at least one of the fixed stops can be monitored for stop—contact in the intended use of the stamping press, wherein the angle of rotation positions of the crank shaft or the eccentric shaft of the stamping press between which the stop contact exists, the angle of rotation of the crank shaft or the eccentric shaft of the stamping press within which the stop contact exists and/or the time period within which the stop contact exists are determined and are compared with target values, and the ram position can be changed as a function of the monitoring result.

40. The stamping press according to claim 39, wherein the die is configured such that the contact of the stop faces of one or more fixed stops establishes or closes one or more electrical contacts which generate a contact—signal for monitoring purposes.

41. The stamping press according to claim 40, wherein, at at least one of the fixed stops, one of the stop faces has two contacts which are short-circuited by the other stop face upon stop contact.

42. The stamping press according to claim 40, wherein, at at least one of the fixed stops, the two stop faces form a contact pair which is closed upon stop contact.

43. The stamping press according to claim 39, wherein the die is configured such that a deformation of a body, which provides one of the contact faces of a fixed stop, taking place under the stop pressure can be detected for monitoring the fixed stop for stop contact, in particular by means of strain gauges and/or piezo elements.

44. The stamping press according to claim 39, wherein the devices for controlling the ram position are configured such that a parameter representing the stop contact can be monitored.

45. The stamping press according to claim 44, wherein the devices for controlling the ram position are configured such that bodies formed by or carried by the two die parts can be monitored, in particular without contact, for a relative position to one another representing the stop contact.

46. The stamping press according to claim 44, wherein the devices for controlling the ram position are configured such that one or more reference stops formed by respectively associated stop faces of the two die parts, at the stop contact of which the monitored fixed stop or stops have stop contact, can be monitored for stop contact, in particular in such a way that the contact of the stop faces of the respective reference stop establishes or closes an electrical contact which generates a contact signal, or that a deformation of a body which takes place under the stop pressure and which provides one of the contact surfaces of the respective reference stop can be detected.

47. (canceled)

48. The stamping press according to claim 39, wherein the devices for controlling the ram position are configured such that the course of the relative movement of the first die part or of the ram relative to the fixed press—structure, the bolster plate or the second die part can be monitored in the region of the bottom dead center of the ram movement, and the ram position can be changed as a function of the monitoring result.

49. The stamping press according to claim 48, wherein the devices for controlling the ram position are configured such that the time or the angle of rotation of the crank drive or eccentric drive can be monitored, during which the first die part or the ram does not perform a relative movement in the region of the bottom dead center of the ram movement with respect to the stationary press structure, the bolster plate or the second die part, and the ram position can be changed as a function of the monitoring result.

50. The stamping press according to claim 39, wherein the devices for controlling the ram position are configured such that the drive torque curve or the power consumption curve of the crank drive or eccentric drive can be monitored in the region of the bottom dead center of the ram movement and the ram position can be changed as a function of the monitoring result.

51. The stamping press according to claim 50, wherein the devices for controlling the ram position are configured such that the time or the angle of rotation of the crank drive or eccentric drive can be monitored, during which the drive torque or the power consumption in the region of the bottom dead center of the ram movement has a certain course or exceeds a certain threshold value, and the ram position can be changed as a function of the monitoring result.

52. The stamping press according to claim 50, wherein the devices for controlling the ram position are configured such that the maximum value which the drive torque or the power consumption reaches in the region of the bottom dead center of the ram movement can be monitored, and the ram position can be changed as a function of the monitoring result.

53. The stamping press according to claim 39, wherein the devices for controlling the ram position are configured such that, in the intended use, the duration of the contact of one or more fixed stops can be kept constant, in particular automatically, by setting the ram position as a function of the monitoring result.

54. The stamping press according to claim 53, wherein the devices for controlling the ram position are configured such that the ram position can be set as a function of the monitoring result in such a way that a specific stop contact duration results, in particular the shortest possible stop contact duration.

55. The stamping press according to claim 39, wherein the die of the stamping press has a plurality of monitored fixed stops and the devices for controlling the ram position are configured such that, in the intended use, a specific constellation of these monitored fixed stops can be brought into stop contact, in particular automatically, by setting the ram position as a function of the monitoring result at each working stroke.

56. The stamping press according to claim 55, wherein the devices for controlling the ram position are configured such that the ram position can be adjusted as a function of the monitoring result in such a way that a fixed stop of the constellation which comes into stop contact last is in stop contact for the shortest possible time.

57. A use of the stamping press according to claim 30 for the production of stampings for predetermined separation points in sheet metal surfaces, in particular for predetermined separation points in sheet metal surfaces for container lids with tear-off or press-in tab.
